(19) United States
(12) Patent Application Publication
(10) Pub. No.: US 2021/0026154 A1
(43) Pub. Date: Jan. 28, 2021

(54) DISPLAY SYSTEM CAPABLE OF SWITCHING DISPLAY MODES

(71) Applicant: BOE TECHNOLOGY GROUP CO., LTD., Beijing (CN)

(72) Inventor: Tao Hong, Beijing (CN)

(21) Appl. No.: 16/307,251

(22) PCT Filed: Feb. 27, 2018
(86) PCT No.: PCT/CN2018/077297

§ 371 Date: Dec. 5, 2018

(30) Foreign Application Priority Data
Jun. 26, 2017 (CN) 201710493226.3

(51) Int. Cl. G02B 27/28; G02B 27/01; G02B 30/25; G02B 5/30

(52) U.S. Cl. CPC G02B 27/286; G02B 27/0101; G02B 2027/0134; G02B 5/3083; G02B 30/25

(57) ABSTRACT

A display system capable of switching display modes includes an optical waveguide, a display mode switching element formed on a surface of the light exit surface, and a display source system. The optical waveguide has a first and a second surfaces parallel to the first surface. The first surface includes a light incident and exit surfaces. The display mode switching element includes a microlens array formed on a surface of the light exit surface and a filled layer formed on the microlens array. The microlens array has two different refractive indices corresponding to S polarized light and P polarized light, and the filled layer has a smaller one of the two different refractive indices. The display source system is used for emitting linearly polarized light capable of switching between S polarization and P polarization towards the light incident surface to provide a display image for the display system.

### CROSS-REFERENCE TO RELATED APPLICATIONS

The present disclosure is based on International Application No. PCT/CN2018/077297, filed on Feb. 27, 2018, which is based on and claims priority to Chinese Patent Application No. 201710493226.3, entitled “Display System Capable of Switching Display Modes”, filed on Jun. 26, 2017, the entire contents of which is hereby incorporated by reference.

### TECHNICAL FIELD

The present disclosure generally relates to the field of display and, in particular, to a display system capable of switching display modes.

### BACKGROUND

In the near-eye display field, when a user wears an augmented reality device, the displayed 3D object is a stereoscopic vision formed by displaying different images to the left and right eyes of the user. Since the 3D display based on binocular stereo vision has a problem of convergence adjustment conflict, the user may feel eye fatigue and dizziness after worn for a long time.

Therefore, a technical problem that needs to be solved at present is to design a novel display system.

The above information disclosed in this background section is only intended to enhance understanding of the background of the present disclosure, and thus it may include information that does not constitute the prior art known to those of ordinary skill in the art.

### SUMMARY

According to an exemplary arrangement of the present disclosure, a display system capable of switching display modes is disclosed. The display system includes an optical waveguide, a display mode switching element formed on a surface of the light exit surface, and a display source system. The optical waveguide has a first surface and a second surface parallel to the first surface. The first surface includes a light incident surface and a light exit surface. Light entering on the light incident surface is emitted from the light exit surface after propagated through the optical waveguide. The display mode switching element includes a microlens array formed on a surface of the light exit surface and a filled layer formed on the microlens array. The microlens array has two different refractive indices corresponding to S polarized light and P polarized light. The filled layer having a smaller one of the two different refractive indices. A display source system is used for emitting linearly polarized light capable of switching between S polarization and P polarization towards the light incident surface to provide a display image for the display system.

In an exemplary arrangement of the present disclosure, the light entering on the light incident surface and emitted from the light exit surface after propagated through the optical waveguide includes the light entering perpendicular to the light incident surface and emitted from the light exit surface in a direction perpendicular to the light exit surface after propagated through the optical waveguide.

In an exemplary arrangement of the present disclosure, the light entering perpendicular to the light incident surface and emitted from the light exit surface in a direction perpendicular to the light exit surface after propagated through the optical waveguide includes the light entering perpendicular to the light incident surface and propagated through the optical waveguide in a direction parallel to the first surface after reflected by an incident reflection surface disposed at a region in the optical waveguide corresponding to the light incident surface. The light entering perpendicular to the light incident surface and emitted from the light exit surface in a direction perpendicular to the light exit surface after propagated through the optical waveguide includes the light propagated through the optical waveguide in a direction parallel to the first surface and emitted in a direction perpendicular to the light exit surface after reflected by a plurality of mutually parallel exit reflection surfaces disposed in a region of the optical waveguide corresponding to the light exit surface. Any of the plurality of exit reflection surfaces and the incident reflection surface form mirror images of each other.

In an exemplary arrangement of the present disclosure, the microlens array has a first refractive index and a second refractive index corresponding to the S polarized light and the P polarized light, respectively. The filled layer has the first refractive index. The second refractive index being greater than the first refractive index.

In an exemplary arrangement of the present disclosure, the display system further includes a linearly polarizer formed on the second surface to merely allow S-polarized light to pass therethrough.

In an exemplary arrangement of the present disclosure, the display system further includes a linearly polarizer formed on the second surface to merely allow P-polarized light to pass therethrough.

In an exemplary arrangement of the present disclosure, the microlens array is composed of a birefringent material.

In an exemplary arrangement of the present disclosure, the optical waveguide is composed of a silicon-based optical waveguide material or a polymer optical waveguide material.

In an exemplary arrangement of the present disclosure, the display source system includes a microdisplay for generating the display image.

In an exemplary arrangement of the present disclosure, the display source system further includes an image rendering unit for outputting a corresponding display image signal to the microdisplay.

In an exemplary arrangement of the present disclosure, the display source system further includes a projection system for converging light emitted by the microdisplay and then projecting in a direction of the light incident surface.

In an exemplary arrangement of the present disclosure, the display source system further includes a polarization switching element for changing a polarization state of light entering the optical waveguide.

In an exemplary arrangement of the present disclosure, the display source system further includes a control unit for controlling at least the polarization switching element to change the polarization state of light entering the optical waveguide.

In an exemplary arrangement of the present disclosure, the display source system further includes a control unit for controlling at least the image rendering unit to output the corresponding display image signal to the microdisplay.

According to some arrangements of the present disclosure, by using a display mode switching element of a microlens array having birefringence, free real-time switching of display modes is achieved, i.e., the display system can be switched to display a natural three-dimensional (3D) image in addition to a normal two-dimensional (2D) image, thus providing great flexibility, and to some extent alleviating a problem of image resolution degradation caused by the method of realizing 3D display by a light field display of the microlens array.

According to some arrangements of the present disclosure, by controlling the polarization state of the external scene light when the natural 3D image is displayed by using the microlens array, the natural 3D display is observed while the external scene is unaffected, thus realizing an augmented reality display effect of superimposing a display object and an external object while realizing switching between display modes.

The above general description and the following detailed description are intended to be illustrative and not restrictive of the present disclosure.

### BRIEF DESCRIPTION OF THE DRAWINGS

The above and other objects, features, and advantages of the present disclosure will become more apparent from the exemplary arrangements with reference to the accompanying drawings.

The accompanying drawings are incorporated in and constitute part of the specification, show the arrangements of the present disclosure and are intended to explain the principle of the present disclosure together with the description. It is apparent that the accompanying drawings in the following description are only some of the arrangements of the present disclosure, and other drawings may be obtained from these accompanying drawings by those skilled in the art without any creative work.

FIG. 1 shows a schematic view of a situation in which the human eye observes the real world.

FIG. 2 shows a schematic view of a stereoscopic 3D display in the prior art.

FIG. 3 shows a schematic view of the microlens array realizing the light field display in the prior art.

FIG. 4 shows a schematic view of a display system capable of switching display modes in accordance with an example arrangement of the present disclosure.

FIG. 5 shows a schematic view of a display mode switching element in a display system capable of switching display modes in accordance with an example arrangement of the present disclosure.

FIG. 6 shows a schematic view of S-polarized light passing through a display mode switching element in a display system capable of switching display modes in accordance with an example arrangement of the present disclosure.

FIG. 7 shows a schematic view of P-polarized light passing through a display mode switching element in a display system capable of switching display modes in accordance with an example arrangement of the present disclosure.

FIG. 8 shows another optical path diagram of a display system capable of switching display modes in accordance with an example arrangement of the present disclosure.

### DETAILED DESCRIPTION

Example arrangements will now be described more fully with reference to the accompanying drawings. However, the example arrangements can be embodied in a variety of forms, and should not be construed as being limited to the arrangements set forth herein; rather, these arrangements are provided so that this disclosure will be thorough and complete, and the concepts of the example arrangements will be fully given to those skilled in the art. The same reference numerals in the drawings denote the same or similar structures, and thus their detailed descriptions will be omitted.

Although the relative terms such as “on”, “below”, “upper” and “lower” are used in the specification to describe the relative relationship of one component to another component, these terms are used in this specification for convenience only, for example, a direction in the example according to the accompanying drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

The terms such as “a”, “an”, “the” and “said” are used to indicate the presence of one or more elements/components; the terms “comprise”, “include”, “have”, “contain” and their variants are used to be open-type and are meant to include additional elements/components, etc., in addition to the listed elements/components/etc.; the terms “first”, “second”, etc. are used only as marks rather than limits for the number of objects.

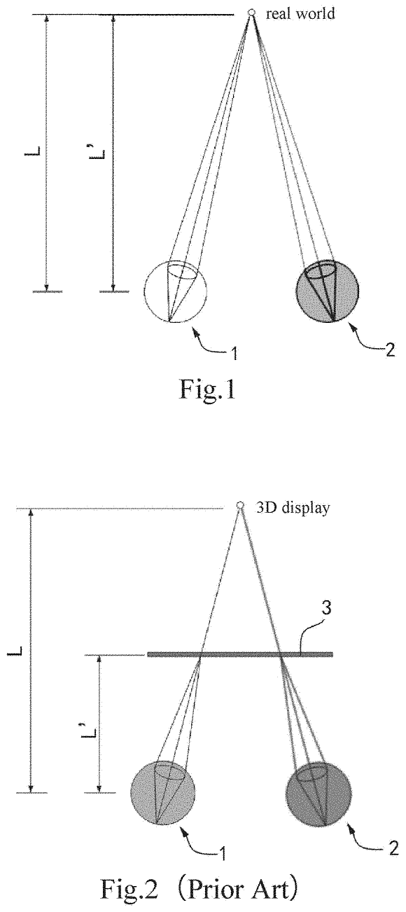

Referring to FIGS. 1-2, FIG. 1 shows a schematic view of a situation in which the human eye observes the real world, and FIG. 2 shows a schematic view of a stereoscopic 3D display in the prior art. In FIGS. 1-2,. 1, 2 and 3 respectively represent a left eye, a right eye, and a display screen, and L and L′ respectively represent a convergence distance and a focus distance. As shown in FIGS. 1-2, since the convergence distance L and the focus distance L′ are equal when the human eye observes the real world, a problem of convergence adjustment conflict does not exit; however, since the convergence distance L and the focus distance L′ are different in stereoscopic 3D display, a problem of convergence adjustment conflict is quite obvious.

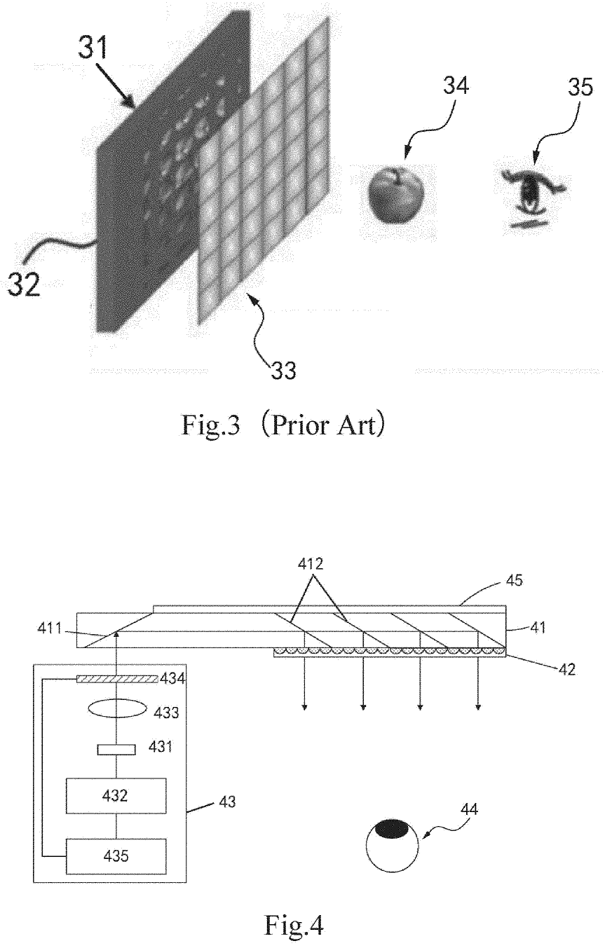

The light field display provides a feasible method to solve the user's eye fatigue and dizziness. Specifically, by simulating the light field of natural 3D objects, natural 3D display is realized to reduce the fatigue and dizziness of the human eye. One method of achieving the light field display is an integrated imaging display using a microlens array. As shown in FIG. 3, reference numbers 31-35 in the figure represent a natural image, a display screen, a microlens array, a 3D image and an observer. An ordinary microlens array may only display a 3D object, and cannot function as display mode switching, and the method of light field display of the microlens array may reduce a resolution of the display image, which is disadvantageous for the practical application of the light field display on the display device.

The present disclosure provides a display system capable of switching display modes, including an optical waveguide, a display mode switching element, and a display source system. The optical waveguide has a first surface adjacent to a human eye and a second surface facing away from the human eye and parallel to the first surface, the first surface including a light incident surface and a light exit surface. Incident light entering on the light incident surface is emitted from the light exit surface after propagated through the optical waveguide; the display mode switching element is formed on a surface of the light exit surface, and the display mode switching element includes a microlens array formed on a surface of the light exit surface and a filled layer formed on the microlens array. The microlens array has two different refractive indices corresponding to S polarized light and P polarized light, the filled layer having a smaller one of the two different refractive indices; the display source system is used for emitting linearly polarized light capable of switching between S polarization and P polarization towards the light incident surface to provide a display image for the display system.

The display system capable of switching display modes of the present disclosure realizes free real-time switching of display modes by using a display mode switching element of a microlens array having birefringence, i.e., the display system can be switched to display a natural 3D image in addition to a normal 2D image, thus providing great flexibility, and to some extent alleviating a problem of image resolution degradation caused by the method of realizing 3D display by a light field display of the microlens array; in addition, by controlling the polarization state of the external scene light when the natural 3D image is displayed by using the microlens array, the natural 3D display is observed while the external scene is unaffected, thus realizing an augmented reality display effect of superimposing a display object and an external object while realizing switching between display modes.

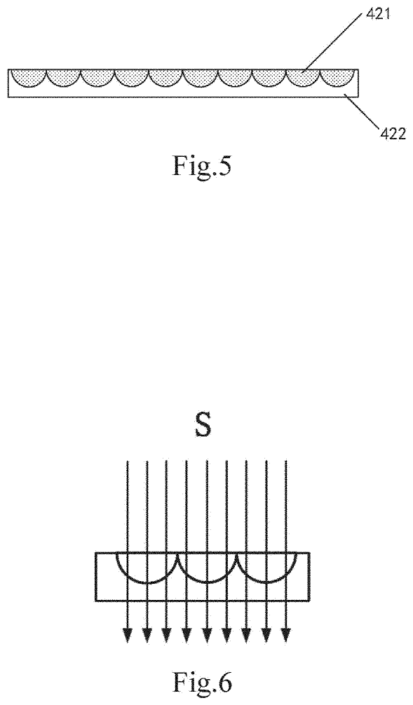

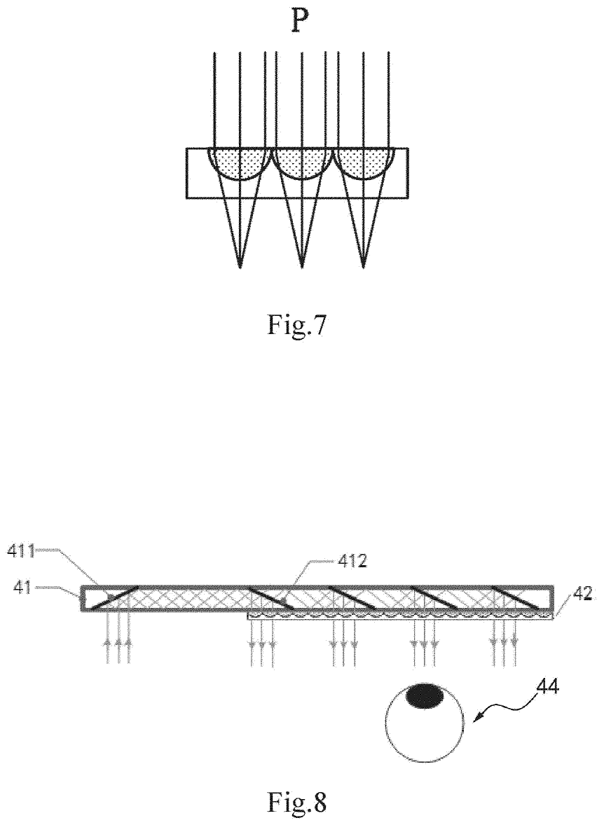

The display system capable of switching display modes of the present disclosure will be specifically described below with reference to FIGS. 4-7. FIG. 4 shows a schematic view of a display system capable of switching display modes in accordance with an example arrangement of the present disclosure; FIG. 5 shows a schematic view of a display mode switching element in a display system capable of switching display modes in accordance with an example arrangement of the present disclosure; FIG. 6 shows a schematic view of S-polarized light passing through a display mode switching element in a display system capable of switching display modes in accordance with an example arrangement of the present disclosure; and FIG. 7 shows a schematic view of P-polarized light passing through a display mode switching element in a display system capable of switching display modes in accordance with an example arrangement of the present disclosure.

As shown in FIGS. 4-5, an exemplary arrangement of a display system capable of switching display modes of the present disclosure includes an optical waveguide 41, a display mode switching element 42, and a display source system 43. The optical waveguide has a first surface adjacent to a human eye 44 and a second surface facing away from the human eye and parallel to the first surface, the first surface including a light incident surface and a light exit surface. Incident light entering on the light incident surface is emitted from the light exit surface after propagated through the optical waveguide. The display mode switching element 42 is formed on a surface of the light exit surface, and the display mode switching element includes a microlens array 421 formed on a surface of the light exit surface and a filled layer 422 formed on the microlens array (as shown in FIG. 5). The microlens array has two different refractive indices corresponding to S polarized light and P polarized light, the filled layer having a smaller one of the two different refractive indices. The display source system 43 is used for emitting linearly polarized light capable of switching between S polarization and P polarization towards the light incident surface to provide a display image for the display system.

The specific principle for the display system realizing switching of display modes in the present disclosure is described below by taking the arrangement in which the 2D display is achieved when the display source system emits the P-polarized light to the light waveguide to realize the 3D display and emit the S-polarized light. Correspondingly, the microlens array has a first refractive index and a second refractive index corresponding to the S polarized light and the P polarized light, respectively, the filled layer has a first refractive index, and the second refractive index is greater than the first refractive index. However, the present disclosure is not limited thereto as long as the microlens array has two different refractive indices corresponding to S polarized light and P polarized light, the filled layer has a smaller refractive index among the two different refractive indexes, which can realize switching of the 3D and the 2D display, i.e., the 3D display can be realized by the S-polarized light and the 2D display can be realized by the P-polarized light, and correspondingly, the microlens array has a first refractive index and a second refractive index corresponding to the P polarized light and the S polarized light, respectively, the filled layer has a first refractive index, and the second refractive index is greater than the first refractive index.

In an arrangement in which the 3D display is realized by the S-polarized light and the 2D display is realized by the P-polarized light, when the light guided in the optical waveguide is the S-polarized light, the refractive index of the microlens and the refractive index of the filled layer are both n1, the display mode switching element is equivalent to a flat glass and does not have a focal power (as shown in FIG. 6), and at this time, the human eye observes a 2D image; when the light guided in the optical waveguide is the P-polarized light, the refractive index of the microlens array is n2, and n2>n1, the display mode switching element has a focal power, which is equivalent to a microlens array (as shown in FIG. 7), so that the human eye observes a 3D image. The display source system 43 changes the polarization state of the light entering the optical waveguide element (changes from P-polarized light to S-polarized light or from S-polarized light to P-polarized light), so that the displayed image is switched between the 2D image and the 3D image by the function of the display mode switching element. In other words, the user can switch between a binocular stereoscopic display and a light field display, so that the light field display provides a natural 3D display, which can eliminate the visual fatigue and dizziness caused by the user's convergence conflict in the ordinary 3D display, thus providing great flexibility, and to some extent alleviating a problem of image resolution degradation caused by the method of realizing 3D display by a light field display of the microlens array.

The microlens array may be made of calcite (CaO.CO2) material. A refractive index of an ordinary light is 1.658, and a refractive index of an extraordinary light is 1.486. The filled layer may be made of polymethyl methacrylate material (PMMA), and the refractive index thereof is about 1.49 (regardless of the polarization state). In the present arrangement, the linearly polarized light in the P direction is the ordinary light, and the linearly polarized light in the S direction is the extraordinary light, so that when it is the linearly polarized light in the S direction, the birefringent microlens array does not affect the light, and can be regarded as an optical flat plate; when it is the linearly polarized light in the P direction, the birefringent microlens array deflects the light and acts as a lens. The material is not limited to the above materials, and may be other types of birefringent materials as long as the refractive index of the filled layer material is approximated to a smaller one of the two refractive indexes of the birefringent material.

A process of the birefringent microlens array is described as follows: a microlens array is processed by using a birefringent material such as calcite, and a shape of a clear aperture of the microlens may be quadrilateral or hexagonal; the filled layer material (such as PMMA) which is softened and melted after heated is pressed and coated on an end of the microlens array material having a lens protrusion, so that the formed end face plane is parallel to an end face plane on the other side of the microlens array, and finally a display mode switching element as geometrically a flat plate is formed. The display mode switching element only functions with a refraction effect of the lens to a light of a certain polarization state, and does not have the refractive effect on a light of the polarization state perpendicular thereto, i.e., an optical plate.

In an exemplary arrangement of the present disclosure, the incident light entering on the light incident surface being emitted from the light exit surface after propagated through the optical waveguide includes: the incident light entering perpendicular to the light incident surface being emitted from the light exit surface in a direction perpendicular to the light exit surface after propagated through the optical waveguide.

In an exemplary arrangement of the present disclosure, the incident light entering perpendicular to the light incident surface being emitted from the light exit surface in a direction perpendicular to the light exit surface after propagated through the optical waveguide includes: the incident light entering perpendicular to the light incident surface being propagated through the optical waveguide in a direction parallel to the first surface after reflected by an incident reflection surface 411 disposed at a region in the optical waveguide corresponding to the light incident surface; the light propagated through the optical waveguide in a direction parallel to the first surface being emitted in a direction perpendicular to the light exit surface after reflected by a plurality of mutually parallel exit reflection surfaces 412 disposed in a region of the optical waveguide corresponding to the light exit surface. Any of the plurality of exit reflection surfaces and the incident reflection surface form mirror images of each other.

It should be particularly noted that, in the above exemplary arrangement, the light enters perpendicular to the light incident surface, and an angle between the incident reflection surface and the light incident surface of the optical waveguide is 45 degrees (as shown in FIG. 4). However, the present disclosure is not limited thereto. The incident light entering the light incident surface may still be emitted from the light exit surface and directed to the human eye after propagated through the optical waveguide when the light does not enter perpendicular to the light incident surface and/or the angle between the incident reflection surface and the light incident surface of the optical waveguide is not 45 degrees, as shown in FIG. 8. At this time, the light entering the optical waveguide is actually propagated to be totally reflected in the optical waveguide, i.e., the light is totally reflected at several times between the first surface and the second surface of the optical waveguide, and reflected by the plurality of exit reflection surfaces 412 of the light exit surface, and then emitted from the light exit surface and projected to the human eye for imaging.

In an exemplary arrangement of the present disclosure, in order to realize an augmented reality display effect of superimposing a display object and an external object while realizing switching of display modes, a linearly polarizer 45 is formed on the second surface to merely allow S-polarized light to pass therethrough, so that only the S-polarized light among light of the external environment can penetrate therethrough, and the display switching element has no focal power for the S-polarized light, which is equivalent to a flat plate. Thus, the light of the external environment can enter the human eye without bending, thus enabling the external object to be undistorted and observed by the user to achieve the augmented reality display effect of superimposing a display object and an external object. In this way, when the natural 3D image is displayed by using the microlens array, the polarization state of the external scene light is controlled, so that the natural scene is not affected while the natural 3D display is observed.

In another exemplary arrangement of the present disclosure, as described in the foregoing arrangements, the 3D display can be realized by the S-polarized light and the 2D display can be realized by the P-polarized light, and correspondingly, the microlens array has a first refractive index and a second refractive index corresponding to the P polarized light and the S polarized light, respectively, the filled layer has a first refractive index, and the second refractive index is greater than the first refractive index. Similarly, in this arrangement, in order to realize an augmented reality display effect of superimposing a display object and an external object while realizing switching of display modes, a linearly polarizer 45 is formed on the second surface to merely allow S-polarized light to pass therethrough.

In an exemplary arrangement of the present disclosure, the optical waveguide is composed of a silicon-based optical waveguide material or a polymer optical waveguide material.

In an exemplary arrangement of the present disclosure, the display source system 43 includes a microdisplay 431 for generating the display image.

In an exemplary arrangement of the present disclosure, the display source system 43 further includes an image rendering unit 432 for outputting a corresponding display image signal to the microdisplay 431.

In an exemplary arrangement of the present disclosure, the display source system 43 further includes a projection system 433 for converging light emitted by the microdisplay 431 and then projecting in a direction of the light incident surface.

In an exemplary arrangement of the present disclosure, the display source system 43 further includes a polarization switching element 434 for changing a polarization state of light entering the optical waveguide.

In an exemplary arrangement of the present disclosure, the display source system 43 further includes a control unit 435 for controlling at least the polarization switching element 434 to change the polarization state of light entering the optical waveguide.

In an exemplary arrangement of the present disclosure, the display source system 43 further includes a control unit 435 for controlling at least the image rendering unit 432 to output a corresponding display image signal to the microdisplay 431.

In addition, it should be particularly noted that the specific configuration of the display source system is not limited to the above arrangement, and may be configured in other ways as long as the linearly polarized light capable of switching between S polarization and P polarization can emit to the light incident surface and the display system provide a display image.

Those skilled in the art will readily appreciate from the above detailed description that the display system capable of switching display modes according to an arrangement of the present disclosure has one or more of the following advantages.

According to some arrangements of the present disclosure, by using a display mode switching element of a microlens array having birefringence, free real-time switching of display modes is achieved, i.e., the display system can be switched to display a natural three-dimensional (3D) image in addition to a normal two-dimensional (2D) image, thus providing great flexibility, and to some extent alleviating a problem of image resolution degradation caused by the method of realizing 3D display by a light field display of the microlens array.

According to some arrangements of the present disclosure, by controlling the polarization state of the external scene light when the natural 3D image is displayed by using the microlens array, the natural 3D display is observed while the external scene is unaffected, thus realizing an augmented reality display effect of superimposing a display object and an external object while realizing switching between display modes.

The above description is only the specific arrangement of the present disclosure, but the scope of the present disclosure is not limited thereto, and those skilled in the art can easily conceive of changes or substitutions within the technical scope of the present disclosure. Those changes or substitutions should be covered within the scope of protection of the present disclosure. Therefore, the scope of protection of the present disclosure should be determined by the scope of the claims.

1. A display system capable of switching display modes, comprising:
an optical waveguide having a first surface and a second surface parallel to the first surface, the first surface comprising a light incident surface and a light exit surface, wherein an incident light entering on the light incident surface is emitted from the light exit surface after propagated through the optical waveguide;
a display mode switching element formed on light exit surface, the display mode switching element comprising a microlens array formed on the light exit surface and a filled layer formed on the microlens array, wherein the microlens array has two different refractive indices corresponding to S polarized light and P polarized light, the filled layer having a smaller one of the two different refractive indices; and
a display source system for emitting linearly polarized light capable of switching between S polarization and P polarization towards the light incident surface to provide a display image for the display system.

2. The display system according to claim 1, wherein the incident light enters perpendicular to the light incident surface, and is emitted from the light exit surface in a direction perpendicular to the light exit surface after propagated through the optical waveguide.

3. The display system according to claim 2, wherein the incident light is propagated through the optical waveguide in a direction parallel to the first surface of the optical waveguide after reflected by an incident reflection surface disposed at a region in the optical waveguide corresponding to the light incident surface, and then is emitted in a direction perpendicular to the light exit surface after reflected by a plurality of mutually parallel exit reflection surfaces disposed in a region of the optical waveguide corresponding to the light exit surface, wherein any of the plurality of exit reflection surfaces and the incident reflection surface form mirror images of each other.

4. The display system according to claim 1, wherein the microlens array has a first refractive index and a second refractive index corresponding to the S polarized light and the P polarized light, respectively, the filled layer has first refractive index, and the second refractive index is greater than the first refractive index.

5. The display system according to claim 4, further comprising a linearly polarizer formed on the second surface of the waveguide to merely allow S-polarized light to pass therethrough.

6. The display system according to claim 1, wherein the microlens array has a first refractive index and a second refractive index corresponding to the P polarized light and the S polarized light, respectively, the filled layer has first refractive index, and the second refractive index is greater than the first refractive index.

7. The display system according to claim 6, further comprising a linearly polarizer formed on the second surface to merely allow P-polarized light to pass therethrough.

8. The display system according to claim 1, wherein the microlens array is composed of a birefringent material.

9. The display system according to claim 1, wherein the optical waveguide is composed of a silicon-based optical waveguide material or a polymer optical waveguide material.

10. The display system according to claim 1, wherein the display source system comprises a microdisplay for generating the display image.

11. The display system according to claim 10, wherein the display source system further comprises an image rendering unit for outputting a corresponding display image signal to the microdisplay.

12. The display system according to claim 10, wherein the display source system further comprises a projection system for converging light emitted by the microdisplay and then projecting in a direction of the light incident surface.

13. The display system according to claim 12, wherein the display source system further comprises a polarization switching element for changing a polarization state of light entering the optical waveguide.

14. The display system according to claim 13, wherein the display source system further comprises a control unit for controlling at least the polarization switching element to change the polarization state of light entering the optical waveguide.

15. The display system according to claim 11, wherein the display source system further comprises a control unit for controlling at least the image rendering unit to output the corresponding display image signal to the microdisplay.
